(19) United States
(12) Patent Application Publication
(10) Pub. No.: US 2023/0122259 A1
(43) Pub. Date: Apr. 20, 2023

(54) ADVERTISEMENT PRINT METHOD AND ADVERTISEMENT PRINT SYSTEM

(71) Applicant: SEIKO EPSON CORPORATION, Tokyo (JP)

(72) Inventors: Tetsuji FUJITA, Chino (JP); Hisashi KOIKE, Suwa (JP); Satoru YANAGI, Tokyo (JP); Tokuro MIYANISHI, Tokyo (JP); Jun TAKIZAWA, Chino (JP); Tomoaki NAKAMURA, Shiojiri (JP); Akio ITO, Matsumoto (JP); Toshiaki MIKOSHIBA, Azumino (JP)

(21) Appl. No.: 18/046,951

(22) Filed: Oct. 17, 2022

(30) Foreign Application Priority Data
Oct. 19, 2021 (JP) 2021-170805

(51) Int. Cl. G06Q 30/02

(52) U.S. Cl. CPC G06Q 30/0276; G06Q 30/0271

(57) ABSTRACT

An advertisement print method includes an advertisement information obtaining step of obtaining, by an advertisement processing apparatus, advertisement information input by an input apparatus, a transaction data selection step of selecting, by the advertisement processing apparatus, N transaction data associated with the advertisement information from a plurality of transaction data stored in an e-commerce database based on the advertisement information and orderer information and receiver information stored in the e-commerce database, N being an integer not less than 1, and a print step of printing, by a print apparatus, an advertisement based on the advertisement information on packing materials of N products specified by the N selected transaction data.

The present application is based on, and claims priority from JP Application Serial Number 2021-170805, filed Oct. 19, 2021, the disclosure of which is hereby incorporated by reference herein in its entirety.

### BACKGROUND

### 1. Technical Field

The present disclosure relates to an advertisement print method and an advertisement print system.

### 2. Related Art

JP-A-2019-2947 discloses a transport delivery advertisement method. In the transport delivery advertisement method, when a transport delivery, such as a notification mail or a direct mail from an insurance company or a credit card company, is dispatched, a processing apparatus selects an advertisement sticker suitable for content of an advertisement of the transport delivery with reference to a database storing advertisement information of advertisement stickers and attaches the selected advertisement sticker to the transport delivery. According to this transport delivery advertisement method, since the content of the advertisement of the transport delivery and the advertisement information of the advertisement sticker attached to the transport delivery are associated with each other, an appeal of the advertisement to a receiver of the transport delivery may be enhanced.

According to the transport delivery advertisement method disclosed in JP-A-2019-2947, although the appeal of the advertisement to the receiver of the transport delivery which is sent for the purpose of the advertisement may be enhanced since content of the advertisement of the transport delivery and advertisement information of the advertisement sticker attached to the transport delivery are associated with each other, the appeal of the advertisement may not be enhanced to a receiver of a transport delivery which is not sent for the purpose of the advertisement, such as a transport delivery of a product ordered on e-commerce.

### SUMMARY

According to an aspect of the present disclosure, an advertisement print method includes an advertisement information obtaining step of obtaining, by an advertisement processing apparatus, advertisement information input by an input apparatus, a transaction data selection step of selecting, by the advertisement processing apparatus, N transaction data associated with the advertisement information from a plurality of transaction data stored in an e-commerce database based on the advertisement information and orderer information and receiver information stored in the e-commerce database, N being an integer not less than 1, and a print step of printing, by a print apparatus, an advertisement based on the advertisement information on packing materials of N products specified by the N selected transaction data.

According to another aspect of the present disclosure, an advertisement print system includes a data storage apparatus that stores e-commerce database storing orderer information, receiver information, and a plurality of transaction data, an advertisement processing apparatus that obtains advertisement information input by an input apparatus, and selects N transaction data associated with the advertisement information from the plurality of transaction data based on the advertisement information, the orderer information, and the receiver information, N being an integer not less than 1, and a print apparatus that prints an advertisement based on the advertisement information on packing materials of N products specified by the N selected transaction data.

### BRIEF DESCRIPTION OF THE DRAWINGS

FIG. 1 is a diagram illustrating an example of a configuration of an e-commerce system including a print system according to an embodiment.

FIG. 2 is a diagram illustrating a flow of various information and various data in the e-commerce system.

FIG. 3 includes examples of tables of a customer list, a product list, a transaction list, and a search list.

FIG. 4 includes examples of tables of orderer information and receiver information.

FIG. 5 is a diagram illustrating examples of product classifications and categories.

FIG. 6 is a diagram illustrating an example of an advertisement information input screen.

FIG. 7 is a diagram illustrating an example of an advertisement printed on a packing material of a delivery.

FIG. 8 is a diagram illustrating another example of an advertisement printed on a packing material of a delivery.

FIG. 9 is a flowchart of an example of a procedure of the advertisement print method according to this embodiment.

### DESCRIPTION OF EXEMPLARY EMBODIMENTS

Hereinafter, a preferred embodiment of the present disclosure will be described in detail with reference to the accompanying drawings. Note that the embodiment below does not unreasonably limit content of the present disclosure disclosed in the claims. It is not necessarily the case that all components described below are requirements of the present disclosure.

Hereinafter, as an advertisement print system and an advertisement print method according to the present disclosure, an advertisement print system constituting a part of an e-commerce system and an advertisement print method executed in the advertisement print system will be described as examples.

### 1. Advertisement Print System

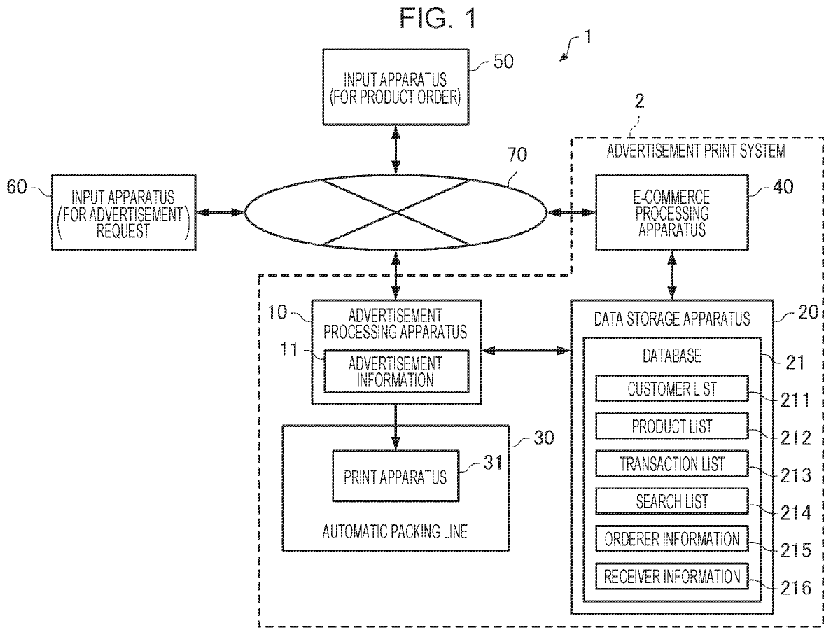

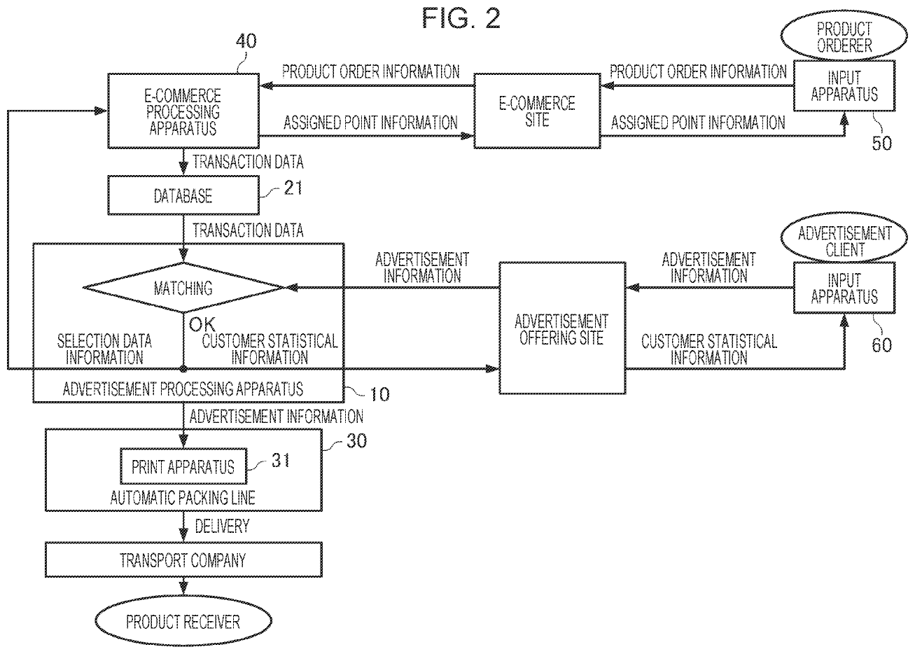

FIG. 1 is a diagram illustrating an example of a configuration of an e-commerce system including an advertisement print system according to this embodiment. FIG. 2 is a diagram illustrating a flow of various information and various data in the e-commerce system.

As illustrated in FIGS. 1 and 2, an e-commerce system 1 includes an advertisement print system 2 including an advertisement processing apparatus 10, a data storage apparatus 20, an automatic packing line 30, and an e-commerce processing apparatus 40, an input apparatus 50, an input apparatus 60, and a communication network 70. In the advertisement print system 2, advertisements based on advertisement information requested by advertisement clients are printed on products to be delivered, and the advertisement print system 2 may additionally include at least one of the input apparatus 50, the input apparatus 60, and the communication network 70.

The advertisement processing apparatus 10, the e-commerce processing apparatus 40, the input apparatus 50, and the input apparatus 60 are coupled to the communication network 70. The communication network 70 is constituted by the Internet or a local area network.

The input apparatus 50, such as a smartphone or a personal computer, is used for product order and is operated by a user of an e-commerce site provided by the e-commerce processing apparatus 40.

In this embodiment, before order of a product, the user operates the input apparatus 50 to input personal information of the user, such as a name, an address, a birthday, an occupation, and a hobby. The input apparatus 50 transmits the input personal information to the e-commerce processing apparatus 40 through the communication network 70 so as to obtain a customer ID of the e-commerce site from the e-commerce processing apparatus 40. The user who has obtained the customer ID searches for a product by inputting a category of the product or a characteristic of the product to the input apparatus 50. When the user desires to purchase a product in a displayed product group, the user may select the product to order the product.

The input apparatus 50 transmits product order information including the customer ID of the user, information on the product ordered by the user, and information on a receiver of the product to the e-commerce processing apparatus 40 through the communication network 70. Furthermore, the input apparatus 50 transmits search history information including the customer ID of the user and information input by the user for searching for the product to the e-commerce processing apparatus 40 through the communication network 70.

Note that, although only one input apparatus 50 for product order is illustrated in FIGS. 1 and 2, input apparatuses 50 of users of the e-commerce site are connected to the communication network 70 in practice, and the individual input apparatuses 50 transmit product order information and search history information to the e-commerce processing apparatus 40 when respective users perform operations for product order or operations for searching for products.

The e-commerce processing apparatus 40 provides the e-commerce site and functions as a server that performs processing on transactions of customers on the e-commerce site.

The e-commerce processing apparatus 40 receives the personal information of the user transmitted from the input apparatus 50 through the communication network 70 and selects a customer ID that is not identical to any of existing customer IDs. Then the e-commerce processing apparatus 40 transmits the selected customer ID to the input apparatus 50 through the communication network 70. Furthermore, the e-commerce processing apparatus 40 generates customer data including the selected customer ID of the user and the personal information of the user and transmits the customer data to the data storage apparatus 20.

Furthermore, the e-commerce processing apparatus 40 receives product order information transmitted from the individual input apparatuses 50 through the communication network 70 and generates orderer data including personal information of product orderers, that is, users who have ordered products, and receiver data including personal information of receivers of the ordered products. Furthermore, the e-commerce processing apparatus 40 generates transaction data including IDs of the generated orderer data, IDs of the generated receiver data, and IDs of the ordered products. Then the e-commerce processing apparatus 40 transmits the generated orderer data, the generated receiver data, and the generated transaction data to the data storage apparatus 20.

Furthermore, the e-commerce processing apparatus 40 receives search history information transmitted from the individual input apparatuses 50 through the communication network 70 and generates search data based on the received search history information. Then the e-commerce processing apparatus 40 transmits the generated search data to the data storage apparatus 20.

The data storage apparatus 20 includes a database 21. The database 21 stores a customer list 211, a product list 212, a transaction list 213, a search list 214, orderer information 215, and receiver information 216.

The customer list 211 is a list of customer data. The data storage apparatus 20 receives customer data from the e-commerce processing apparatus 40 and adds the received customer data to the customer list 211.

The product list 212 is a list of product data including information on products which are available for purchase by the users.

The transaction list 213 is a list of transaction data. The data storage apparatus 20 receives transaction data from the e-commerce processing apparatus 40 and adds the received transaction data to the transaction list 213.

The search list 214 is a list of search data. The data storage apparatus 20 receives search data from the e-commerce processing apparatus 40 and adds the received search data to the search list 214.

The orderer information 215 is a list of orderer data. The data storage apparatus 20 receives orderer data from the e-commerce processing apparatus 40 and adds the received orderer data to the orderer information 215.

The receiver information 216 is a list of receiver data. The data storage apparatus 20 receives receiver data from the e-commerce processing apparatus 40 and adds the received receiver data to the receiver information 216.

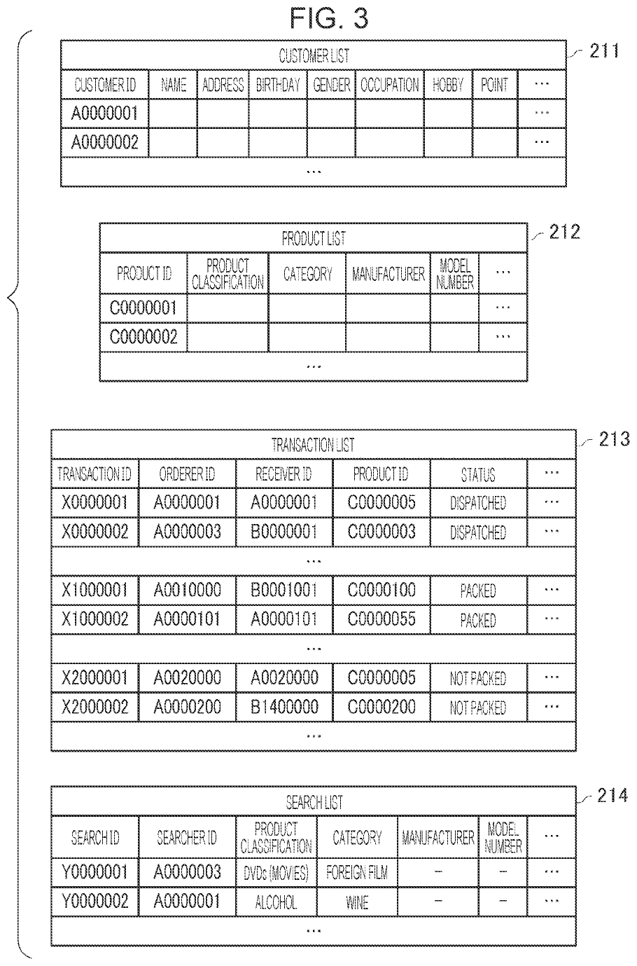

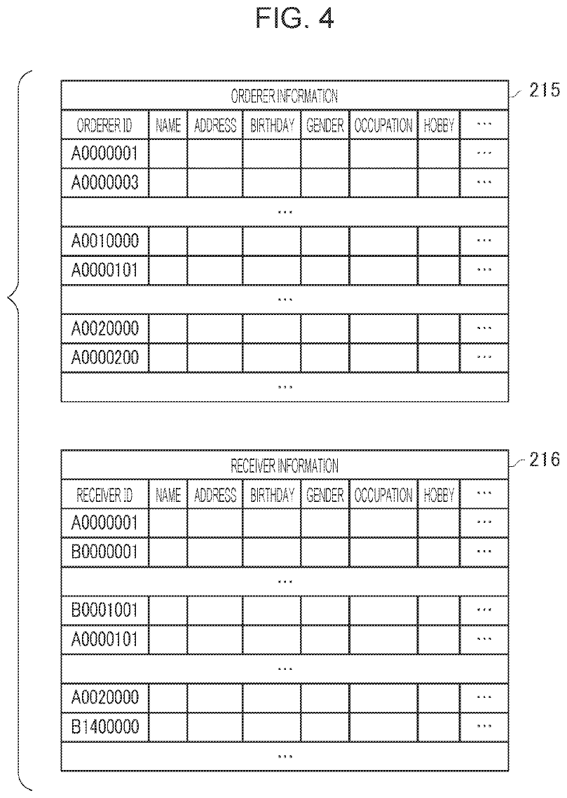

FIG. 3 includes examples of tables of the customer list 211, the product list 212, the transaction list 213, and the search list 214 that are stored in the database 21. FIG. 4 includes examples of tables of the orderer information 215 and the receiver information 216.

In the examples of FIG. 3, customer data included in the customer list 211 includes information on a customer ID, a name, an address, a birthday, a gender, an occupation, points, and the like. The customer ID is information for identifying customer data and different customer IDs are assigned to different customer data.

Product data included in the product list 212 includes information on a product ID, a product classification, a category, a manufacturer, a model number, and the like. The product ID is information for identifying product data and different product IDs are assigned to different product data. The product classification is rough classification for roughly classifying product groups, and the category is a small category for further categorizing the product groups classified by the product classification.

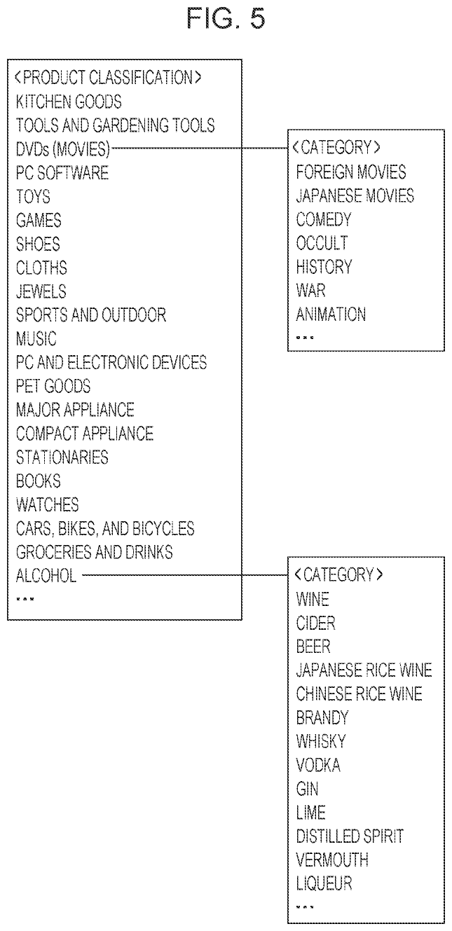

FIG. 5 is a diagram illustrating examples of product classifications and categories. In the examples of FIG. 5, examples of the product classifications include “kitchen goods”, “tools and gardening tools”, “DVDs (movies)”, “PC software”, “toys”, “games”, “shoes”, “cloths”, “jewels”, “sports and outdoor”, “music”, “PC and electronic devices”, “pet goods”, “major appliance”, “compact appliance”, “stationaries”, “books”, “watches”, “cars, bikes, and bicycles”, “groceries and drinks”, and “alcohol”. Furthermore, examples of categories of “DVDs (movies)” that is one of the product classifications include “foreign movies”, “Japanese movies”, “comedy”, “occult”, “history”, “war”, and “animation”. Examples of categories of “alcohol” that is one of the product classifications include “wine”, “cider”, “Japanese rice wine”, “Chinese rice wine”, “brandy”, “vodka”, “gin”, “lime”, “distilled spirit”, “vermouth”, and “liqueur”.

Furthermore, in the example of FIG. 3, each transaction data included in the transaction list 213 includes information on a transaction ID, an orderer ID, a receiver ID, a product ID, and a status. The transaction ID is information for identifying transaction data, and different transaction IDs are assigned to different transaction data.

The orderer ID is information for identifying a product orderer and matches one of the customer IDs. For example, an orderer ID included in transaction data having a transaction ID “X0000001” is “A0000001”, and a customer corresponding to customer data having a customer ID “A0000001” included in the customer list 211 is a product orderer.

The receiver ID is information for identifying a product receiver and matches one of customer IDs or one of receiver IDs of the receiver data. For example, a receiver ID included in the transaction data having the transaction ID “X0000001” is “A0000001”, and a customer corresponding to customer data having the customer ID “A0000001” included in the customer list 211 is a product receiver. Furthermore, for example, a receiver ID included in transaction data having a transaction ID “X0000002” is “B0000001”, and a person corresponding to receiver data having the receiver ID “B0000001” included in the receiver information 216 illustrated in FIG. 4 is a product receiver.

The product ID is information for identifying an ordered product and matches one of product IDs of the product data. For example, a product ID included in the transaction data having the transaction ID “X0000001” is “C0000005”, and a product corresponding to product data having a product ID “C0000005” included in the product list 212 is an ordered product.

The status is information indicating a state of an ordered product, and examples of the state of an ordered product include “dispatched”, “packed”, and “not packed”.

In the examples of FIG. 4, the orderer data included in the orderer list 215 includes information on an orderer ID, a name, an address, a birthday, a gender, and an occupation. The orderer ID is information for identifying an orderer and matches one of the customer IDs. Then information on the name, the address, the birthday, the gender, and the occupation of the each orderer data coincides with information on the name, the address, the birthday, the gender, and the occupation included in the customer data including a customer ID that matches the orderer ID. For example, information on a name, an address, a birthday, a gender, an occupation, and the like included in orderer data having an orderer ID “A0000001” illustrated in FIG. 4 coincides with information on a name, an address, a birthday, a gender, an occupation, and the like included in customer data having a customer ID “A0000001” illustrated in FIG. 3.

In the examples of FIG. 4, the receiver data included in the receiver information 216 includes information on a receiver ID, a name, an address, a birthday, a gender, and an occupation. The receiver ID is information for identifying a receiver, and a receiver ID obtained when a receiver is a user who has obtained a customer ID coincides with the customer ID. For example, a receiver ID of receiver data generated based on product order information in which information on a product receiver matches information on customer data of a product orderer coincides with a customer ID of the product orderer. When the receiver ID of the receiver data matches any one of the customer IDs, information on a name, an address, a birthday, a gender, an occupation, and the like of the receiver data coincides with information on a name, an address, a birthday, a gender, an occupation, and the like included in customer data including the customer ID. For example, information on a name, an address, a birthday, a gender, an occupation, and the like included in receiver data having a receiver ID “A0000001” illustrated in FIG. 4 coincides with information on a name, an address, a birthday, a gender, an occupation, and the like included in customer data having a customer ID “A0000001” illustrated in FIG. 3.

On the other hand, a receiver ID of a receiver who has not obtained a customer ID does not coincide with any of the customer IDs. When the receiver ID of the receiver data does not match any of the customer IDs, information on a name, an address, a birthday, a gender, an occupation, and the like of the receiver data coincides with information on a name, an address, a birthday, a gender, an occupation, and the like of a product receiver included in product order information corresponding to the receiver data. For example, information on a name, an address, a birthday, a gender, an occupation, and the like included in receiver data having a receiver ID “B0000001” illustrated in FIG. 4 coincides with information on a name, an address, a birthday, a gender, an occupation, and the like of a product receiver included in the product order information. Note that, when information on a birthday, a gender, an occupation, or the like of a product receiver is not included in the product order information, the information on the birthday, the gender, the occupation, and the like of the product receiver is not included in receiver data corresponding to the product order information.

In this way, the database 21 stores big data including a large amount of transaction data, a large amount of search data, a large amount of orderer data, and a large amount of receiver data.

Referring back to FIGS. 1 and 2, the input apparatus 60 is used for an advertisement request and operated by an advertisement client who requests advertisement to an advertisement offering site provided by the advertisement processing apparatus 10. Examples of the input apparatus 60 include a smartphone and a personal computer. Alternatively, the input apparatus 60 may be a terminal dedicated for an advertisement request.

In this embodiment, an advertisement client inputs advertisement information by operating the input apparatus 60. Specifically, the advertisement client operates the input apparatus 60 so that an advertisement information input screen for requesting an advertisement is displayed on a display of the input apparatus 60, and inputs advertisement information on the advertisement information input screen. The input apparatus 60 transmits the input advertisement information to the advertisement processing apparatus 10 through the communication network 70.

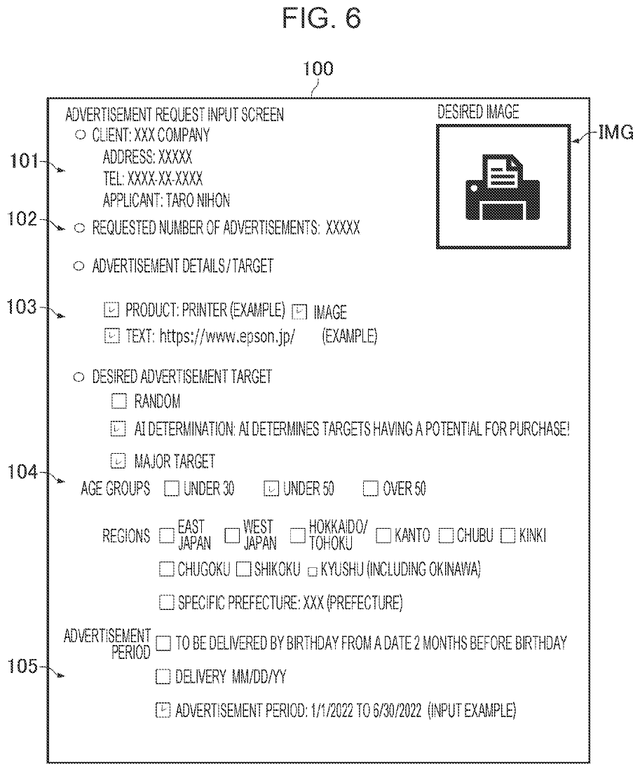

FIG. 6 is a diagram illustrating an example of the advertisement information input screen. An advertisement information input screen 100 illustrated in FIG. 6 includes an advertisement client information input field 101 for input of information on an advertisement client. The advertisement client inputs required information to the advertisement client information input field 101. In the example of FIG. 6, the advertisement client inputs a company name, an address, a telephone number, and a name of the advertisement client in the advertisement client information input field 101.

Furthermore, the advertisement information input screen 100 includes a request number input field 102, and the advertisement client inputs the desired number of advertisements to the advertisement number input field 102.

Furthermore, the advertisement information input screen 100 includes an advertisement content input field 103 for input of content or a target of an advertisement, and the advertisement client inputs required information to the advertisement content input field 103. In the example of FIG. 6, the advertisement client may input a target of the advertisement, an image IMG to be displayed as the advertisement, and text to be displayed as the advertisement to the advertisement content input field 103.

The advertisement information input screen 100 further includes a desired advertisement target input field 104, and the advertisement client inputs required information to the desired advertisement target input field 104. In the example of FIG. 6, the advertisement client may input a selection indicating whether an advertisement target is to be randomly extracted or determined by an AI, an age group of the advertisement target, and a resident area of the advertisement target in the desired advertisement target input field 104.

The advertisement information input screen 100 further includes an advertisement period designation input field 105 for input of information on an advertisement period, and the advertisement client inputs required information to the advertisement period designation input field 105. In the example of FIG. 6, the advertisement client may input, to the advertisement period designation input field 105, a delivery period or a delivery date of a delivery product on which an advertisement is printed and an advertisement period.

The input apparatus 60 generates advertisement information including various information input to the advertisement client information input field 101, the request number input field 102, the advertisement content input field 103, the desired advertisement target input field 104, and the advertisement period designation input field 105 and transmits the generated advertisement information to the advertisement processing apparatus 10 through the communication network 70.

Referring back to FIGS. 1 and 2, the advertisement processing apparatus 10 receives the advertisement information transmitted from the input apparatus 60 through the communication network 70. Specifically, the advertisement processing apparatus 10 obtains advertisement information 11 input by the input apparatus 60. Then the advertisement processing apparatus 10 selects N transaction data (N is an integer not less than 1) associated with the advertisement information 11 from a plurality of transaction data included in the transaction list 213 stored in the database 21 based on the obtained advertisement information 11 and the orderer information 215 and the receiver information 216 stored in the e-commerce database 21. All the N selected transaction data corresponds to a status “not packed”. Furthermore, the integer N is a value having an upper limit corresponding to the desired number of advertisements included in the advertisement information 11.

The advertisement processing apparatus 10 may arbitrarily select N transaction data of content corresponding to the advertisement information 11. Specifically, when the advertisement information 11 includes information indicating that arbitrary extraction of advertisement targets has been selected, the advertisement processing apparatus 10 determines whether information on a birthday and an address of receiver data specified by a receiver ID of the transaction data matches information on an age group and a resident area of the advertisement targets included in the advertisement information 11 for each transaction data of the status “not packed”. When the receiver data specified by the receiver ID of the transaction data of the status “not packed” does not include the information on a birthday and when the orderer information 215 includes orderer data that matches the information on a name and an address of the receiver data, the advertisement processing apparatus 10 determines whether the information on a birthday and an address of the orderer data matches the information on an age group and a resident area of the advertisement targets included in the advertisement information 11. Then the advertisement processing apparatus 10 arbitrarily selects N transaction data from among a group of the matched transaction data.

For example, in the example of FIGS. 3 and 4, since a receiver ID of transaction data having a status “not packed” and having a transaction ID “X2000001” is “A0020000”, the advertisement processing apparatus 10 refers to receiver data having a receiver ID “A0020000” included in the receiver information 216. The receiver ID “A0020000” is also a customer ID, and therefore, the receiver data having the receiver ID “A0020000” includes information on a birthday and an address. Therefore, the advertisement processing apparatus 10 determines whether information on a birthday and an address of the receiver data having the receiver ID “A0020000” matches information on an age group and a resident area of the of the advertisement targets included in the advertisement information 11.

Furthermore, since a receiver ID of transaction data having a status “not packed” and having a transaction ID “X2000002” is “B1400000”, the advertisement processing apparatus 10 refers to receiver data having a receiver ID “B1400000” included in the receiver information 216. The receiver ID “B1400000” is not a customer ID, and therefore, the receiver data having the receiver ID “B1400000” may include information on an address but not include information on a birthday. In this case, the advertisement processing apparatus 10 searches the orderer information 215 for orderer data having a name and an address that coincide with those of the receiver data of the receiver ID “B1400000”. For example, when a name and an address of orderer data of an orderer ID “A0010000” coincide with a name and an address of the receiver data of the receiver ID “B1400000”, the orderer ID “A0010000” is also a customer ID, and therefore, the orderer data of the orderer ID “A0010000” includes information on a birthday. Therefore, the advertisement processing apparatus 10 determines whether information on a birthday and an address of the orderer data having the orderer ID “A0010000” matches information on an age group and a resident area of the of the advertisement targets included in the advertisement information 11.

Furthermore, the advertisement processing apparatus 10 may performs machine learning based on a plurality of transaction data included in the transaction list 213, the orderer information 215, and the receiver information 216 and select N transaction data associated with the advertisement information 11 from the plurality of transaction data based on the machine learning. Specifically, when the advertisement information 11 includes information indicating that an AI determination of advertisement targets is selected, the advertisement processing apparatus 10 performs machine learning based on the transaction list 213, the orderer information 215, and the receiver information 216, determines association between the transaction data and the advertisement information 11 based on the machine learning, and selects N transaction data that is highly associated with the advertisement information 11. The advertisement processing apparatus 10 may determine the association between the individual transaction data and the advertisement information 11 based on at least one of an address, a birthday, a gender, an occupation, and a hobby of a product receiver, for example. The advertisement processing apparatus 10 may perform machine learning by various analysis methods including cross tabulation, cluster analysis, association analysis, logistic regression analysis, decision tree analysis, and base analysis or may perform machine learning by deep learning.

For example, when a printer is an advertising object, the advertisement processing apparatus 10 analyzes information on persons having a printer purchase history and selects N transaction data that corresponds to the status “not packed” and that corresponds to a product receiver who are highly likely to purchase a printer. The persons who have a printer purchase history may be customers who have ordered a printer before or product receivers who received a printer ordered by such customers, but the persons are preferably customers who have ordered a printer before and also product receivers who received the printer ordered by the customers. The advertisement processing apparatus 10 analyzes a large number of items, including an age group, family members, a gender, a resident area, and history of purchase of products other than printers, of a person who has a printer purchase history, for example. For example, such information that a person having a printer purchase history is in 40s, has an elementary-age child, lives in a city, a town, or a village having population of 50000 or more, purchases a printer every 5 to 10 years, has purchase history of travel books, workbooks for learning, and stationaries in addition to printers may be obtained as a result of the cross tabulation, the cluster analysis, base analysis, or the like. In this way, it is important to analyze information on persons who purchase a product of an advertising object in the past, and in particular, it is important to extract products purchased by persons who have purchased the product of the advertising object. Then the advertisement processing apparatus 10 selects N transaction data that matches information on a person having a printer purchase history obtained by the analysis from among a plurality of transaction data having a status of “not packed”, for example. The advertisement processing apparatus 10 may assign priority order to the analyzed items, perform weighting in accordance with the priority order so as to obtain scores, and select N transaction data in descending order of total scores.

Note that the advertisement processing apparatus 10 may analyze information on a person having printer search history based on the search list 214 and select N transaction data based on information on a person having printer purchase history or printer search history.

Furthermore, a product or a service of an advertising object may not be included in the product list 212, and in this case, the advertisement processing apparatus 10 preferably obtains information on the product to be advertised or a customer segment of the service from an advertisement client or the like. For example, when a hotel is an advertising object, the advertisement processing apparatus 10 obtains, from the input apparatus 60, information on ages, occupations, genders, and the like of a main segment of customers who use the hotel in addition to the advertisement information 11. For example, when a main customer segment corresponds to company workers in 30s and 40s, the advertisement processing apparatus 10 analyzes a product associated with the hotel among products purchased or searched for by the company workers of 30s or 40s, for example. For example, as a result of the analysis, information indicating that company workers of men in 30s to 40s are likely to purchase business books and travel books as products associated with the hotel and information indicating that a person who purchases a business book is likely to purchase leather shoes are obtained. In this case, the advertisement processing apparatus 10 selects, from among a plurality of transaction data having a status “not packed”, N transaction data in which a product receiver is a company worker of man in 30s to 40s and a product corresponds to a business book, a travel book, leather shoes, or a thing similar to one of a business book, a travel book, and leather shoes.

When a message for celebrating a birthday is an advertising object, for example, the advertisement processing apparatus 10 may select N transaction data in which dispatch dates of products are close to birthdays of product receivers arbitrarily or by machine learning. Alternatively, the advertisement processing apparatus 10 may perform machine learning to analyze birthdays of persons having purchase history of a certain product and the correlation between product purchase dates and the birthdays, and select N transaction data in which dispatch dates of products are close to birthdays of product receivers and the product receivers are highly likely to purchase other products from among a plurality of transaction data having a status “not packed”.

Furthermore, for example, when a region-limited product is an advertising object, for example, the advertisement processing apparatus 10 may select N transaction data in which a status thereof is “not packed” and addresses of product receivers are included in a region where the region-limited products are sold arbitrarily or by machine learning. Moreover, for example, the advertisement processing apparatus 10 may perform machine learning to select N transaction data in which a status thereof is “not packed” and ordered products are similar to a product of an advertising object.

Note that, in any of a case where an advertisement client selects arbitrary extraction of an advertisement target and a case where an advertisement client selects AI determination, when the advertisement information 11 includes information on an age group and a resident area of the advertisement target and an advertisement period, the advertisement processing apparatus 10 selects N transaction data in which birthdays and addresses of product receivers match an age group and a resident area of an advertisement target and product dispatch dates match an advertisement period.

As illustrated in FIGS. 1 and 2, the advertisement processing apparatus 10 transmits the advertisement information 11 and the N selected transaction data to the print apparatus 31 included in the automatic packing line 30.

The automatic packing line 30 obtains various transaction data of a status “not packed” among a plurality of transaction data included in the transaction list 213 stored in the database 21 and automatically packs products specified by the obtained transaction data by packing materials. For example, the packing materials are boxes and envelops made by various materials. The packed products are transferred to a transport company that transports the products to product receivers.

The automatic packing line 30 includes the print apparatus 31 that receives the advertisement information 11 and the N selected transaction data transmitted from the advertisement processing apparatus 10. Then the print apparatus 31 prints an advertisement based on the advertisement information 11 on packing materials of N products specified by the N selected transaction data. The advertisement printed on the packing materials may include at least one of a character, a barcode, a QR code (registered trademark), a picture, and a photograph. Advertisement cost charged to the advertisement client is determined based on the number of copies of the advertisement and the number of print dots, for example.

Note that agreement of printing of an advertisement on a product is preferably obtained from product orderers, and therefore, when each of the orderers operates the input apparatus 50 to order a product, the orderer may input information indicating whether printing of an advertisement on the product is allowable, and product order information may include the information indicating whether printing of an advertisement on the product is allowable. The e-commerce processing apparatus 40 generates, based on the product order information, in addition to a transaction ID, an orderer ID, a receiver ID, a product ID, and a status, transaction data including information indicating whether an advertisement may be printed on a product. Then the advertisement processing apparatus 10 selects N transaction data in which a status thereof is “no packed” and printing of an advertisement on a product is allowed.

Furthermore, the print apparatus 31 prints addresses and names of individual product receivers and addresses and names of product orderers specified by the N selected transaction data on packing materials of N products.

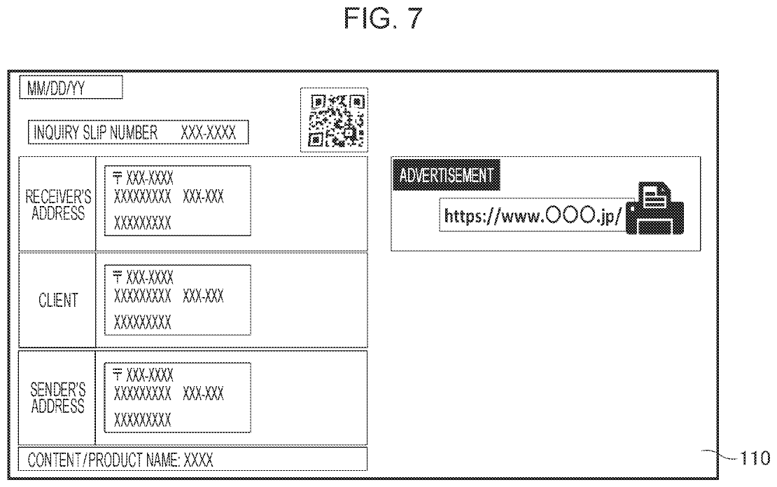

FIG. 7 is a diagram illustrating an example of an advertisement printed on a packing material of a delivery. In the example of FIG. 7, in addition to an address and a name of a product receiver and an address and a name of a product orderer, an image of a printer and a URL are printed as an advertisement on a packing material 110. The product receiver may realize details of functions and the like of the printer with reference to URL printed on the packing material 110. In the example of FIG. 7, an advertisement client is a manufacturer of a printer, for example.

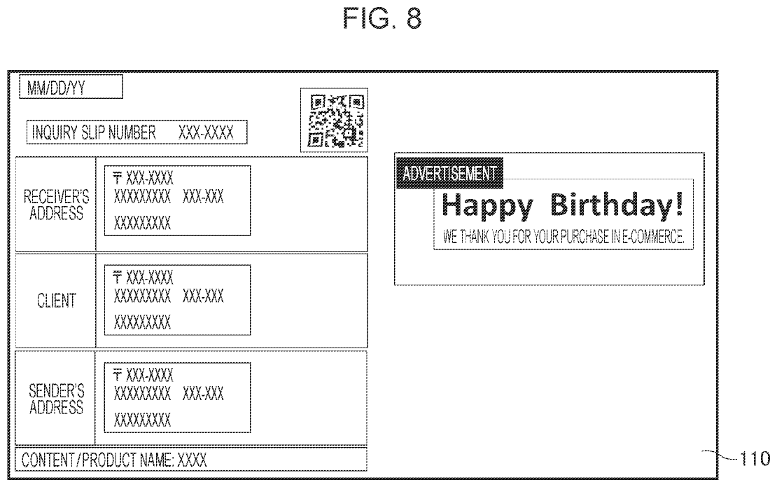

FIG. 8 is a diagram illustrating an example of another advertisement printed on a packing material of a delivery. In the example of FIG. 8, in addition to an address and a name of a product receiver and an address and a name of a product orderer, a message for celebrating a birthday of a product receiver is printed on a packing material 110 as an advertisement. In the example of FIG. 8, an advertisement client is an e-commerce site operating company, for example.

As illustrated in FIGS. 7 and 8, the print apparatus 31 preferably prints an advertisement and an address and a name of a product receiver and an address and a name of a product orderer on the same plane of the packing material 110. By this, visibility of the advertisement is enhanced when the product receiver views the address and the name of the product receiver and the address and the name of the product orderer, and therefore, an appeal of the advertisement is enhanced.

Note that the print apparatus 31 prints addresses and names of product receivers and addresses and names of product orderers that are specified by respective transaction data on the packing materials 110 of products specified by the transaction data having a status “not packed” other than the N selected transaction data but does not print the advertisement information 11.

As illustrated in FIGS. 1 and 2, the advertisement processing apparatus 10 transmits selection data information indicating N selected transaction data, that is, N transaction data corresponding to N products on which an advertisement is to be printed, to the e-commerce processing apparatus 40.

The e-commerce processing apparatus 40 receives the selection data information and assigns points to individual product orderers specified by the N selected transaction data. Specifically, the e-commerce processing apparatus 40 makes an access to the database 21 so as to add certain points generated by advertising to an item “point” in customer data specified by customer IDs that are orderer IDs of the selected transaction data. Thereafter, the e-commerce processing apparatus 40 transmits assigned point information indicating that predetermined points has been assigned to the input apparatus 50 of a customer who is a product orderer through the e-commerce site.

Furthermore, the advertisement processing apparatus 10 performs feedback of customer statistical information including at least the integer N, delivery areas of N products, age distribution of receivers of the N products, and gender distribution of the receivers of the N products to an advertisement client based on the N selected transaction data. Specifically, the advertisement processing apparatus 10 transmits the customer statistical information to the input apparatus 60 of the advertisement client through the advertisement offering site. Note that the advertisement processing apparatus 10 may perform feedback of the customer statistical information to the advertisement client only when the integer N is equal to or larger than a predetermined value so that personal information of the product receiver is not identified by the customer statistic information.

### 2. Advertisement Print Method

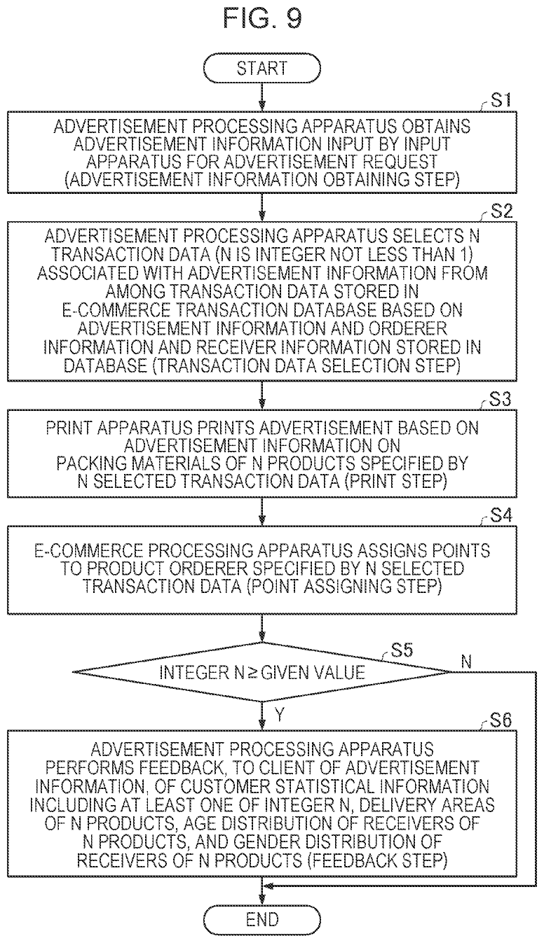

FIG. 9 is a flowchart of an example of a procedure of the advertisement print method according to this embodiment. In this embodiment, any of the advertisement processing apparatus 10, the print apparatus 31, and the e-commerce processing apparatus 40 included in the advertisement print system 2 performs steps in FIG. 9.

First, in an advertisement information obtaining step S1, the advertisement processing apparatus 10 obtains the advertisement information 11 input by the input apparatus 60 for an advertisement request.

Next, in a transaction data selection step S2, the advertisement processing apparatus 10 selects N transaction data (N is an integer not less than 1) associated with the advertisement information 11 from a plurality of transaction data stored in the transaction list 213 stored in the database 21 based on the advertisement information 11 obtained in step S1 and the orderer information 215 and the receiver information 216 stored in the e-commerce database 21. In the transaction data selection step S2, the advertisement processing apparatus 10 may perform machine learning based on the plurality of transaction data stored in the database 21, the orderer information 215, and the receiver information 216 and select N transaction data associated with the advertisement information 11 from the plurality of transaction data based on the machine learning.

Subsequently, in a print step S3, the print apparatus 31 prints an advertisement based on the advertisement information 11 on packing materials 110 of N products specified by the N transaction data selected in step S2. Furthermore, in the print step S3, the print apparatus 31 prints addresses and names of individual receivers specified by the N transaction data selected in step S2 on the packing materials 110 of the N products. The print apparatus 31 may prints an advertisement and the addresses and the names of the individual receivers on the respective same planes of the packing materials 110.

Thereafter, in a point assigning step S4, the e-commerce processing apparatus 40 assigns points to product orderers specified by the N transaction data selected in step S2.

When the integer N is equal to or larger than a predetermined value in step S5, the advertisement processing apparatus 10 performs feedback, in a feedback step S6, of customer statistical information including at least the integer N, delivery areas of the N products, age distribution of the receivers of the N products, and gender distribution of the receivers of the N products to a client of the advertisement information 11 based on the N transaction data selected in step S2 and then terminates the process.

When the integer N is smaller than the predetermined value in step S5, the advertisement processing apparatus 10 terminates the process without performing the process in step S6.

Note that, in the flowchart of FIG. 9, order of the steps may be appropriately changed. For example, step S4 may be performed after step S2 and before step S3. Similarly, step S5 and step S6 may be performed after step S2 and before step S3. Furthermore, step S4 may be omitted or step S5 and step S6 may be omitted.

### 3. Effects

According to the advertisement print system 2 and the advertisement print method according to this embodiment, the advertisement processing apparatus 10 selects N transaction data associated with the advertisement information 11 based on the orderer information 215 and the receiver information 216 stored in the e-commerce database 21, and the print apparatus 31 prints an advertisement based on the advertisement information 11 on the packing materials 110 of N product specified by the N selected transaction data. Accordingly, receiver of individual products are highly likely to be interested in the advertisement printed on the packing materials 110. Therefore, according to the advertisement print system 2 and the advertisement print method of this embodiment, an appeal of the advertisement to a receiver of a product ordered by e-commerce may be enhanced.

According to the advertisement print system 2 and the advertisement print method of this embodiment, the advertisement processing apparatus 10 obtains the advertisement information 11 input by the input apparatus 60 and selects N transaction data associated with the obtained advertisement information 11, and the print apparatus 31 prints an advertisement based on the advertisement information 11 on the packing materials 110 of the N products specified by the N selected transaction data. Specifically, according to the advertisement print system 2 and the advertisement print method of this embodiment, a time point when a product is ordered in e-commerce is not a start point but a time point when an advertisement client requests an advertisement is a starting point, and therefore, a time lag from when the advertisement client requests an advertisement to when the product receiver views the advertisement is short. Furthermore, according to the advertisement print system 2 and the advertisement print method of this embodiment, an advertisement may be viewed by a product receiver at an appropriate timing desired by an advertisement client, and therefore, an appeal of the advertisement to the receiver of the product may be enhanced.

Furthermore, according to the advertisement print system 2 and the advertisement print method of this embodiment, printing of an advertisement and an address and a name of a receiver is performed on a packing material 110 of a product, instead of attachment of a sticker on which the advertisement and the address and the name of the receiver are described. Therefore, according to the advertisement print system 2 and the advertisement print method of this embodiment, an adhesive is not attached to the packing material 110, and therefore, the advertisement does not disturb paper recycle of the packing material 110.

Furthermore, according to the advertisement print system 2 and the advertisement print method of this embodiment, an advertisement and an address and a name of a product receiver are printed on the same plane of a packing material 110, and therefore, the possibility that the product receiver views the advertisement when checking the address and the name of the receiver printed on the packing material 110 is increased so that an appeal of the advertisement to the product receiver may be enhanced.

Furthermore, according to the advertisement print system 2 and the advertisement print method of this embodiment, since the advertisement processing apparatus 10 selects N transaction data associated with the advertisement information 11 based on machine learning, the association between the advertisement information 11 and the individual selected transaction data may be enhanced. Accordingly, the possibility that product receivers are interested in the advertisement printed on packing materials 110 is increased and an appeal of the advertisement may be enhanced

Furthermore, according to the advertisement print system 2 and the advertisement print method of this embodiment, product purchase cost is substantially reduced since points are assigned to orderers of the products on which the advertisement is printed. The operation company of the e-commerce site refunds a portion of the advertisement cost received from the advertisement client by points, and therefore, this difference is a return for the operation company.

Furthermore, according to the advertisement print system 2 and the advertisement print method of this embodiment, the advertisement client may efficiently use the customer statistic information that has been fed back for analysis of adequacy of the advertisement information 11 and planning of advertisement strategy.

### 4. Modifications

The present disclosure is not limited to the foregoing embodiment and various modifications may be made within the scope of the present disclosure.

For example, although an example of the database 21 is illustrated in FIGS. 3 and 4 in the foregoing embodiment, a configuration of the database 21 is not limited to the configuration illustrated in FIGS. 3 and 4. For example, each transaction data of the transaction list 213 may include orderer data corresponding to the orderer information 215 and receiver data corresponding to the receiver information 216. Specifically, the transaction list 213 may include the orderer information 215 and the receiver information 216.

Furthermore, although a product orderer is limited to a user who has obtained a customer ID of the e-commerce site in the foregoing embodiment, for example, a user who has not obtained a customer ID may order a product. When a product orderer is a user who has obtained a customer ID, an orderer ID coincides with the customer ID, whereas when a product orderer is a user who has not obtained a customer ID, a new orderer ID which is different from any of customer IDs is assigned.

The foregoing embodiment and the modifications are merely examples and the present disclosure is not limited to these. For example, the foregoing embodiment and the modifications may be appropriately combined with each other.

The present disclosure includes configurations substantially the same as the configuration described in the foregoing embodiment (for example, configurations having the same functions, methods, and results, or configurations having the same purposes and effects). Furthermore, the present disclosure includes configurations obtained by replacing a portion that is not essential to the configuration of the foregoing embodiment. Moreover, the present disclosure includes configurations that may attain the same effects or the same purposes as the configuration described in the foregoing embodiment. Furthermore, the present disclosure includes configurations obtained by adding the general techniques to the configuration of the foregoing embodiment.

The following is lead from the embodiment and the modifications described above.

According to an aspect of the present disclosure, an advertisement print method includes an advertisement information obtaining step of obtaining, by an advertisement processing apparatus, advertisement information input by an input apparatus, a transaction data selection step of selecting, by the advertisement processing apparatus, N transaction data associated with the advertisement information from a plurality of transaction data stored in an e-commerce database based on the advertisement information and orderer information and receiver information stored in the e-commerce database, N being an integer not less than 1, and a print step of printing, by a print apparatus, an advertisement based on the advertisement information on packing materials of N products specified by the N selected transaction data.

In this advertisement print method, the advertisement processing apparatus selects N transaction data associated with the advertisement information based on the orderer information and the receiver information stored in the e-commerce database, and the print apparatus prints an advertisement based on the advertisement information on the packing materials of the N product specified by the N selected transaction data. Accordingly, receivers of the individual products are highly likely to be interested in the advertisement printed on the packing materials. Therefore, according to the advertisement print method, an appeal of the advertisement to a receiver of a product ordered by e-commerce may be enhanced.

Furthermore, according to the advertisement print method, the advertisement processing apparatus obtains the advertisement information input by the input apparatus and selects N transaction data associated with the obtained advertisement information, and the print apparatus prints an advertisement based on the advertisement information on the packing materials of the N products specified by the N selected transaction data. Specifically, according to the advertisement print method, a time point when a product is ordered in e-commerce is not a start point but a time point when an advertisement client requests an advertisement is a starting point, and therefore, a time lag from when the advertisement client requests an advertisement to when a product receiver views the advertisement is short. Therefore, according to the advertisement print method, the advertisement may be viewed by the product receiver at an appropriate timing desired by the advertisement client, and therefore, an appeal of the advertisement to the receiver of the product may be enhanced.

Furthermore, according to the advertisement print method, since an advertisement is printed instead of attachment of a sticker on which the advertisement is described, an adhesive is not attached to a packing material, and therefore, the advertisement does not disturb paper recycle of the packing material.

According to a further aspect of the present disclosure, in the advertisement print method, in the print step, the print apparatus may print addresses and names of individual receivers specified by N selected transaction data on packing materials of N products.

According to the advertisement print method, since an address and a name of a receiver are printed on a packing material instead of attachment of a sticker on which the address and the name of the receiver are described, an adhesive is not attached to the packing material, and therefore, an advertisement does not disturb paper recycle of the packing material.

According to a still further aspect of the present disclosure, in the advertisement print method, in the print step, the print apparatus may print an advertisement and addresses and names of individual receivers on the respective same planes of the packing materials.

According to the advertisement print method, the possibility that a product receiver views the advertisement when checking the address and the name printed on the packing material is increased, and therefore, an appeal of the advertisement to the receiver of the product may be enhanced.

According to a still further aspect of the present disclosure, in the advertisement print method, in the transaction data selection step, the advertisement processing apparatus may perform machine learning based on the plurality of transaction data stored in the database, the orderer information, and the receiver information and select N transaction data associated with the advertisement information from the plurality of transaction data based on the machine learning.

According to the advertisement print method, since the association between the advertisement information and the individual selected transaction data may be enhanced by the machine learning, the possibility that the product receiver is interested in the advertisement printed on the packing material is increased and an appeal of the advertisement may be enhanced.

According to an aspect of the present disclosure, the advertisement print method may further include a point assigning step of assigning, by an e-commerce processing apparatus, points to product orderers specified by the N selected transaction data.

According to the advertisement print method, product purchase cost is substantially reduced since points are assigned to the orderers of the products on which the advertisement is printed. The operation company of the e-commerce site refunds a portion of the advertisement cost received from the advertisement client by points, and therefore, this difference is a return for the operation company.

According to an aspect of the present disclosure, an advertisement print method may further include a feedback step of performing, by the advertisement processing apparatus, feedback of customer statistical information including at least one of the integer N, delivery areas of the N products, age distribution of receivers of the N products, and gender distribution of the receivers of the N products to a client of the advertisement information based on the N selected transaction data.

According to the advertisement print method, the advertisement client may efficiently use the customer statistic information that has been fed back for analysis of adequacy of the advertisement information and planning of advertisement strategy.

According to another aspect of the present disclosure, an advertisement print system includes a data storage apparatus that stores e-commerce database storing orderer information, receiver information, and a plurality of transaction data, an advertisement processing apparatus that obtains advertisement information input by an input apparatus, and selects N transaction data associated with the advertisement information from the plurality of transaction data based on the advertisement information, the orderer information, and the receiver information, N being an integer not less than 1, and a print apparatus that prints an advertisement based on the advertisement information on packing materials of N products specified by the N selected transaction data.

According to the advertisement print system, the advertisement processing apparatus selects N transaction data associated with the advertisement information based on the orderer information and the receiver information stored in the e-commerce database, and the print apparatus prints an advertisement based on the advertisement information on the packing materials of the N product specified by the N selected transaction data. Accordingly, receivers of the individual products are highly likely to be interested in the advertisement printed on the packing materials. Therefore, according to the advertisement print system, an appeal of the advertisement to a receiver of a product ordered by e-commerce may be enhanced.

Furthermore, according to the advertisement print system, the advertisement processing apparatus obtains the advertisement information input by the input apparatus and selects N transaction data associated with the obtained advertisement information, and the print apparatus prints an advertisement based on the advertisement information on the packing materials of the N products specified by the N selected transaction data. Specifically, according to the advertisement print system, a time point when a product is ordered in e-commerce is not a start point but a time point when an advertisement client requests an advertisement is a starting point, and therefore, a time lag from when the advertisement client requests an advertisement to when the product receiver views the advertisement is short. Therefore, according to the advertisement print system, an advertisement may be viewed by a product receiver at an appropriate timing desired by an advertisement client, and therefore, an appeal of the advertisement to the receiver of the product may be enhanced.

Furthermore, according to the advertisement print system, since an advertisement is printed on a packing material instead of attachment of a sticker on which an advertisement is described, the advertisement does not disturb paper recycle of the packing material.

What is claimed is:

1. An advertisement print method, comprising:
an advertisement information obtaining step of obtaining, by an advertisement processing apparatus, advertisement information input by an input apparatus;
a transaction data selection step of selecting, by the advertisement processing apparatus, N transaction data associated with the advertisement information from a plurality of transaction data stored in an e-commerce database based on the advertisement information and orderer information and receiver information stored in the e-commerce database, N being an integer not less than 1; and
a print step of printing, by a print apparatus, an advertisement based on the advertisement information on packing materials of N products specified by the N selected transaction data.

2. The advertisement print method according to claim 1, wherein, in the print step, the print apparatus prints addresses and names of individual receivers specified by the N selected transaction data on packing materials of N products.

3. The advertisement print method according to claim 2, wherein, in the print step, the print apparatus prints the advertisement and the addresses and the names of the individual receivers on the same planes of the respective packing materials.

4. The advertisement print method according to claim 1, wherein, in the transaction data selection step, the advertisement processing apparatus performs machine learning based on the plurality of transaction data stored in the database, the orderer information, and the receiver information and selects N transaction data associated with the advertisement information from the plurality of transaction data based on the machine learning.

5. The advertisement print method according to claim 1, further comprising:
a point assigning step of assigning, by an e-commerce processing apparatus, points to product orderers specified by the N selected transaction data.

6. The advertisement print method according to claim 1, further comprising:
a feedback step of performing, by the advertisement processing apparatus, feedback of customer statistical information including at least one of the integer N, delivery areas of the N products, age distribution of receivers of the N products, and gender distribution of the receivers of the N products to a client of the advertisement information based on the N selected transaction data.

7. An advertisement print system, comprising:
a data storage apparatus that stores e-commerce database storing orderer information, receiver information, and a plurality of transaction data;
an advertisement processing apparatus that obtains advertisement information input by an input apparatus, and selects N transaction data associated with the advertisement information from the plurality of transaction data based on the advertisement information, the orderer information, and the receiver information, N being an integer not less than 1; and
a print apparatus that prints an advertisement based on the advertisement information on packing materials of N products specified by the N selected transaction data.
